(19) United States
(12) Patent Application Publication
(10) Pub. No.: US 2007/0124452 A1
(43) Pub. Date: May 31, 2007

(54) Urtone

(76) Inventor: Azmat Mohammed, Manchester (GB)

Correspondence Address: MICHAEL RIES, 318 PARKER PLACE, OSWEGO, IL, 60543, US

(21) Appl. No.: 11/607,147

(22) Filed: Nov. 30, 2006

Related U.S. Application Data
(60) Provisional application No. 60/741,257, filed on Nov. 30, 2005.

(51) Int. Cl. G06F 15/173

(52) U.S. Cl. 709/223

(57) ABSTRACT

A system and method for administering, designing and distributing content to a device having systems for transferring content from a content owner to a storage system; for interacting with a user; for selecting a type of device; for selecting desired content for the device; for editing the desired content; for requesting the desired content; for processing the request; for creating the desired content in a format that is accessible to the user's device; for notifying the user that the created, desired content is ready for use; and for tracking sales of the content. The system and method may have a Mobile Gateway Server, IPX and a user interface. The content may be a ringtone, video tone, bespoke application, off-the-shelf application, game, screensaver or wallpaper. The device may be a mobile telephone, cellular telephone, media storage device, website or electronic card.

### CROSS-REFERENCE TO RELATED APPLICATION

This application claims the benefit of U.S. Provisional Application No. 60/741,257, filed Nov. 30, 2005, which is incorporated herein by reference in its entirety.

### TECHNICAL FIELD AND BACKGROUND

The present invention generally relates to mobile or cellular telephones, media storage devices, websites, electronic cards and the like. More specifically, the present invention relates to multimedia systems and methods for managing revenue generated by the sale of ringtones, video tones, applications (bespoke or off-the-shelf), games, screensavers, wallpaper and the like and for administering, designing and distributing the ringtones, video tones, applications (bespoke or off-the-shelf), games, screensavers, wallpaper and the like to mobile or cellular telephones, media storage devices, websites, electronic cards and the like.

The global market for ringtones, video tones, applications (bespoke or off-the-shelf), games, screensavers, wallpaper and the like for use with mobile or cellular telephones, media storage devices, websites, electronic cards and the like is growing and shows no signs of slowing down. Users of such devices seek new ways to design, edit and personalize their mobile or cellular telephones, media storage devices, websites, electronic cards and the like. For example, as of the time of the filing of the present application, the global ringtone market alone is expected to be worth over $5 billion USD in the next two years.

In order to personalize a device, users seek to change the ringtones, video tones, applications (bespoke or off-the-shelf), games, screensavers, wallpaper and the like that are provided with the device from the manufacturer or loaded by the service provider. Typically, for example, a user loads a ringtone onto a mobile telephone either by directly loading the ringtone from a local computer through a cable or short-range wireless connection or by downloading the ringtone from a remote server through the user's mobile telephone network. The content of the ringtone itself is often fixed by the provider of the ringtone. In the case of copyrighted ringtones, the revenue stream generated by the sale of a ringtone may not be readily accessible to the owner of the copyright.

### BRIEF DESCRIPTION OF THE DRAWINGS

The present invention will be described by way of exemplary embodiments, but not limitations, illustrated in the accompanying drawings in which like references denote similar elements, and in which:

FIG. 1 shows a screenshot of one portion of a multi-step, multi-component, multi-function process for a multimedia system and method of the present invention, where a country or language is selected.

FIG. 2 shows a screenshot of one portion of a multi-step, multi-component, multi-function process for a multimedia system and method of the present invention, where a track is selected.

FIG. 3 shows a screenshot of one portion of a multi-step, multi-component, multi-function process for a multimedia system and method of the present invention, where a make and model of a mobile telephone is selected.

FIG. 4 shows a screenshot of one portion of a multi-step, multi-component, multi-function process for a multimedia system and method of the present invention, where a track is edited.

FIG. 5 shows a screenshot of one portion of a multi-step, multi-component, multi-function process for a multimedia system and method of the present invention, where information relating to the transfer of a ringtone is displayed.

FIG. 6 shows a flow chart of a precuts procedure.

FIGS. 7A and 7B show a flow chart of a create your own procedure.

FIG. 8 shows a flow chart of databases used in a multimedia system and method of the present invention.

FIG. 9 shows a flow chart of a multimedia system and method of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation. The phrase in one embodiment is used repeatedly. The phrase generally does not refer to the same embodiment, however, it may. The terms comprising, having and including are synonymous, unless the context dictates otherwise.

The multimedia system and method of the present invention establishes a new niche that does not compete with current traditional sales of ringtones, video tones, applications (bespoke or off-the-shelf), games, screensavers, wallpaper and the like and caters to an entirely new market.

The multimedia system and method of the present invention may comprise a software program that allows a user to easily create a ringtone, video tone, application, game, screensaver, wallpaper or the like from any part of the ringtone, video tone, application, game, screensaver, wallpaper or the like in a few easy steps then send the ringtone, video tone, application, game, screensaver, wallpaper or the like to their mobile or cellular telephone, media storage device, website, electronic card or the like.

In the present invention, a user or end user may be, for example, a person who is a subscriber connected to a wireless network, a customer of a licensee, and/or a person using an appropriate mobile telephone handset capable of playback of the files sold using the multimedia system and method of the present invention files. A wireless network may be a mobile telephone network.

The software may be integrated with mobile carriers, which means the user can get the ringtone, video tone, application, game, screensaver, wallpaper or the like on all supported mobile networks.

The multimedia system and method of the present invention has media content from all the major media suppliers, including, but not limited to all types of ringtones, video tones, applications, games, screensavers, wallpaper or the like. The multimedia system and method is adapted to grow and is adapted for constant updates.

The multimedia system and method of the present invention may also provide video tones, wallpaper and animations for mobile or cellular telephones, media storage devices, websites, electronic cards or the like.

The multimedia system and method of the present invention is aimed at both a youth market and those wishing to utilize media content features, such as MP3 capabilities, of mobile or cellular telephones, media storage devices, websites, electronic cards or the like. The present system and method may include video tones and full-track audio downloads.

The multimedia system and method of the present invention works on websites and may be installed into a retail space. For example, the multimedia system and method of the present invention may comprise a flat touch screen that is mounted on a wall with appropriate signage around the screen or may be incorporated into a kiosk. The flat panel may be connected to a computer and may be adapted for stand-alone operation. That is, the flat panel may operate without connection to the internet or any other type of connectivity.

Monthly updates may be provided on a DVD disc and may be adapted such that an operator of the system inserts the update disc. Upon insertion of the update disc, the system may be adapted to automatically update.

The multimedia system and method of the present invention may be adapted to provide sales data to the media suppliers specifying, for example, what media content was sold and marketing trends for analysis.

There are distinct advantages and benefits derived from the multimedia system and method of the present invention. The present system and method does not replace current revenue streams from ringtones, video tones, applications, games, screensavers, wallpaper or the like and provides a separate additional, unlimited stream of sales of ringtones, video tones, applications, games, screensavers, wallpaper or the like to media suppliers. The present system and method works on multiple platforms, for example, with compact discs, websites and electronic cards. The media supplier does not incur production costs and receives new revenue from the sale of ringtones, video tones, applications, games, screensavers, wallpaper or the like. The present system and method provides a secure revenue source for the media supplier and does not require the use of additional software. The present system and method enhances the earning potential of any one individual ringtone, video tone, screensaver, wallpaper or the like by allowing the user to edit or personalize the content to their personal preference and in a manner adapted to the parameters of the individual's media device.

The present system and method may be adapted to display content from a media supplier or redistributor. For example, the system and method may display a homepage of a record label or media content related to a particular artist.

The present system and method may be adapted to send e-mail or any other suitable type of communication to a media supplier or any other recipient for marketing and tracking purposes. For example, if a particular song track is popular for ringtone sales, the artist could be alerted that people in a particular geographical region or demographic group are interested in the artist's content.

Reciprocal links, conventional media advertising and other forms of advertising may be set up on artist or media supplier websites allowing such groups to add the capabilities of the multimedia system and method of the present invention without incurring additional costs to the artist or media supplier.

The multimedia system and method of the present invention may be marketed on a container for storing a media storage device. For example, the multimedia system and method of the present invention may be marketed on a sleeve of a compact disc carrying software for implementing the present system and method. Also, a compact disc may include an insert advertising a website running software that implements the present system and method. As such, for example, a user buys the compact disc of a favorite artist and is immediately notified of the existence of the present system and method for delivering custom content to their device.

In the present system and method, a user may, for example, pick any part of a true-tone song. Other formats for ringtones include, but are not limited to true-tone, real-tone or MP3, and which may be formatted by a company using the present system and method in a manner enabling them to be transmitted as WAP messages (or any other delivery method deemed relevant) and downloaded onto those mobile telephone handsets capable of receiving files specified in the present specification. A user may have the ability to slide a bar over a length of a song to pick a custom track for their ringtone. A user may be able to reduce or expand the length of the bar. The software of the present system and method may be adapted to recognize a model of a phone and to supply media in an appropriate format for the phone. The user may choose media content from an extensive media or content library. A content library is a collection of files holding the content files (described in greater detail herein) and may reside on a server of a company (media supplier) using the present system and method. Data may be stored on an enhanced compact disc, DVD, electronic card, website, kiosk, dual disc or any other suitable media storage format.

The present system and method may be adapted to deliver a ringtone, video tone, application, game, screensaver, wallpaper or the like via WAP-push. For example, media content may be accessed when a user sends a character string, which passes through a mobile gateway. The string may be deciphered in a server and linked to a clip, which is sent via WAP-push back to a handset directly or via a mobile aggregator, via mobile gateway or directly via the mobile carrier or mobile service provider. The present system and method may be adapted to supply a user with the string, which may be sent from the mobile device in order to signal the delivery of the selected ringtone, video tone, application, game, screensaver, wallpaper or the like.

A user may have the option to preview a custom made ringtone, video tone, application, game, screensaver, wallpaper or the like before purchase.

In the present system and method, a server may be provided, which comprises software, which determines via the string which song was selected, which part of the song was selected, which handset format was selected and delivers the relevant clip via WAP-push. Ringtones, video tones, applications, games; screensavers, wallpaper or the like may be adapted for delivery with or without digital rights management (DRM). In the present system and method, servers may be adapted for continuous operation such that they constantly listen for requests from a mobile gateway. A server or cluster of servers may be adapted to carry media content, which may be pre-encoded, in various formats for use with various handsets.

The present system and method is adapted for any type of ringtone format, including but not limited to SMAF, MP3, RMF(BEATNIK), AMR NERROW BAND, AMR WIDE BAND, AMR WB, MFMP, WAV SAGEM, WAV IMA, WAV and WAV PCM.

The present system and method is adapted for use with multiple types of content including but not limited to TrueTone, Real Tone, MC and all variations of MC, Polyphonic compatible, Midi, RTTTL, MP3, Video Tone compatible files, Mpeg4, Jpegs, Gifs, bmp, Animated file formats for use on mobile or cellular telephones, media storage devices, websites, electronic cards or the like, MMS compatible formats, SP-MIDI, SMAF, Flash video, Real and all other formats not mentioned above that are relevant to ringtone playback, image display and video playback on mobile or cellular telephones, media storage devices, websites, electronic cards or the like. Content includes picture-messages, which are video tones formatted in a manner enabling them to be transmitted to and downloaded onto mobile telephone handsets capable of receiving such files. Delivery of these files to mobile or cellular telephones, media storage devices, websites, electronic cards or the like may be by any suitable method, including, but not limited to, SMS, WAP-push technology or other methods deemed suitable by a company using the present system and method to deliver content to mobile devices.

Content includes audio, video and picture files provided to a company using the present system and method for use with the software of the multimedia system and method of the present invention. In particular, the content is provided for the purpose of sales of ringtones, video tones, applications, games, screensavers, wallpaper or the like via the multimedia system and method of the present invention and software for the same.

The content may be made available for use by a licensee worldwide as part of the present system and method. The software for use with the multimedia system and method of the present invention may be adapted to catalogue sales and activities. For example, the system and method may be adapted to catalogue sales via kiosk, CD, DVD and other versions of the present system and method.

The present system and method may be adapted to assess a license fee or license fee per chargeable unit. In the present specification, a license fee may be a fee for the use of content owned by a copyright holders. The license fee is generally calculated for use of the content in a certain country or worldwide and wherever the multimedia system and method of the present invention software is available, including but not limited to kiosks, websites, CDs, DVDs, electronic cards and the like. Also, a royalty fee may be calculated, where a royalty fee is a fee payable in respect of the delivery of each chargeable unit consisting of or incorporating the whole or any part of a ringtone, video tone, application, game, screensaver, wallpaper or the like. It is understood that revenues will vary for each territory and may be governed by local companies for distribution to subscribers. Copyright holders may be an individual or a company providing content to a company using the present system and method. The copyright holders may also be the company using the present system and method. The territory may be an individual jurisdiction or country or simply worldwide. The present system and method is adapted to determine the revenue from a sale based on a local sale price and local network charges per territory.

The multimedia system and method of the present invention also supports video tones in all supported formats for video and mobile devices, screen savers (both animated and static), wallpaper in all supported formats, polyphonic and monophonic pre-cut ringtones, java games and bespoke applications for mobile devices.

The multimedia system and method of the present invention may include a marketing system, where a copyright holder agrees to market the service utilizing the multimedia system and method of the present invention in an active way, This may be accomplished by displaying content from a media supplier or redistributors, by sending e-mail or any other suitable type of communication to a media supplier or any other recipient for marketing and tracking purposes, by including advertising in any suitable format and by use on websites.

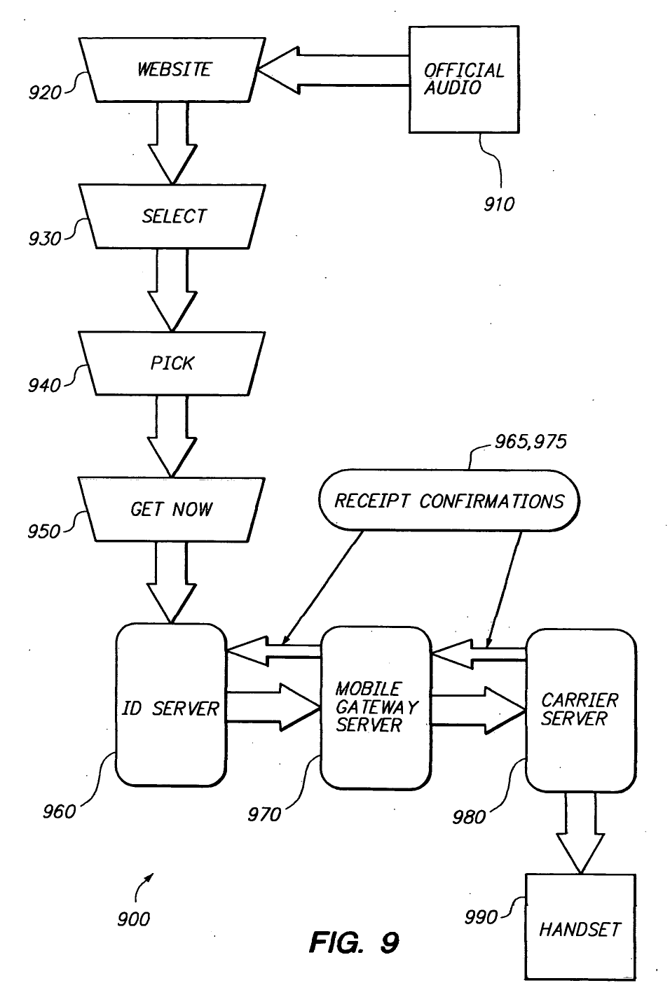

FIG. 9 shows a flow chart of a multimedia system and method 900 of the present invention. The system and method 900 may comprise one or more of the following steps, components or functions:

Step, component, function 910 where a content owner, such as a record company, supplies media content streaming into a database of the present invention via a folder holding encrypted media content on a server. The server may also comprise a website.

Step, component, function 920 where a web site with a user interface according to the present invention is loaded into a browser. The web site may run off client or with an ID web server.

Step, component, function 930 where a user selects their phone model and desired artist and track from a dynamic drop down box. XML files hosted on the client server populate these fields.

Step, component, function 940 where the user uses the slider bar to pick a part of a song and may be resized to a desired length within the parameters of the user's device.

Step, component, function 950 where a user selects his carrier from a drop down box, enters their cell number, and presses “GET NOW” or some variation of that button.

Step, component, function 960 where an ID Server receives the request, cuts the media, creates a download file and tabulates all data.

Steps, components, functions 965, 975 where receipt confirmations go from server to server and ends in a premium SMS terminating at the phone, which is subject to billing.

Step, component, function 970 where a Mobile Gateway Server receives a request from the ID Server, communicates with the ID Server, and sends information to the Carrier Server.

Step, component, function 980 where the Carrier Server receives information from the Mobile Gateway Server, communicates with the Mobile Gateway Server, and sends information to the handset.

Step, component, function 990 where the user's handset receives an SMS and a WAP-push of the content. The handset downloads the content.

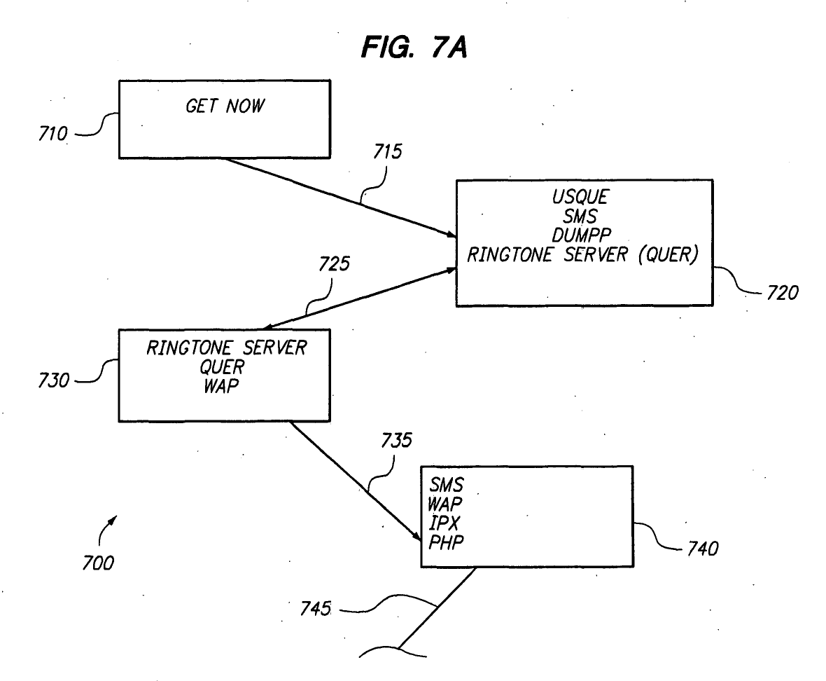

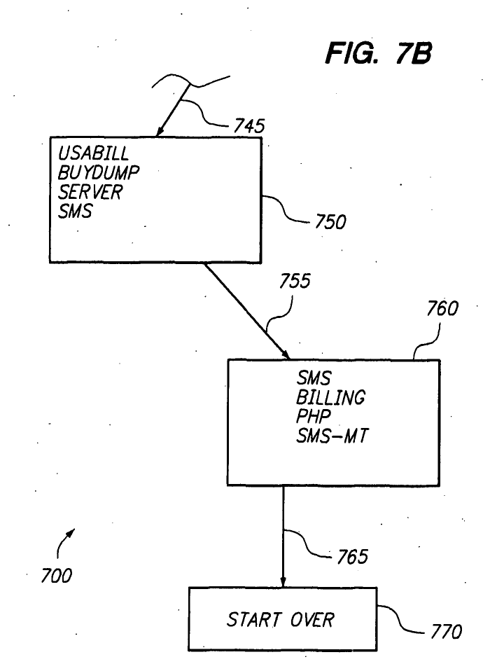

FIGS. 7A and 7B show a flow chart of a procedure for administering, designing and distributing a ringtone according to one embodiment of the present invention.

FIGS. 7A and 7B show a flow chart of a procedure 700. The procedure 700 may include one or more of the following components, functions or steps:

Step 710 where a Flash File is provided, a user enters a phone number and clicks a “GET NOW” or similar button.

Step, Component, Function 715 where one or more of the following values are sent: 1. MSISDN, 2. TIME, 3. STRINGCODE, 4. MESSAGEID, 5. OPERATOR, and 6. SC. Data is saved in the SERVER database, for example, in SQL server 2000, in the table named USQUE.

Step, Component, Function 720 where the USQUE table is constantly checked by the SMS Server for USA, on getting an entry in table, entry is copied to DUMPP table for record and is forwarded to RINGTONE SERVER (QUER table) for processing.

Step, Component, Function 725 where one or more of the SMS values are saved in QUER table for processing by the RINGTONE SERVER, as follows: 1. MSISDN, 2. TIME, 3. STRINGCODE, 4. MESSAGEID, 5. OPERATOR, and 6. SC.

Step, Component, Function 730 where the RINGTONE SERVER clears QUER Table off the entry, creates the ringtone, places the ringtone sending information in WAP table along with the link and places the actual ringtone in the WAP folder.

Step, Component, Function 735 where the WAP table in SERVER database contains the information of the link, cell number, songid, etc, so the link can be constructed by the SMS server and sent to the customer-through a PHP WAP Page, e.g. “c.php”.

Step, Component, Function 740 where the SMS server picks the information from the WAP table and sends it to the user via IPX, which permits communication with any mobile telephone carrier, through a PHP page, e.g. “sendwappushipx.php”, which also creates a log of outgoing SMS. The entry is removed from WAP table, and an example of link user gets is: The entry is removed from the WAP table and an example of a link the user gets is as follows, where “Buy” is a link to the download media file: “[company name] Your customized ringtone is ready! Click Buy to download. Remember to save it once the download is complete. A one-off charge of $2.49 applies. To opt-out reply with STOP.”

Steps, Components, Functions 745 and 750 where the user executes the link, downloads the ringtone, video tone, application, game, screensaver, wallpaper or the like, sends one or more of the following values to USABILL and BUYDUMP tables in SERVER database: 1. Cellnumber, 2. Operator; 3. the Link the user was shown. These values stay until consumed by the SMS server for billing.

Step, Component, Function 755 where SMS server clears the USABILL table off the information received from the user's handset when the user executed the link and processes it for billing.

Step, Component, Function 760 where SMS server places a comprehensive billing in the URTONE database BILLING table and uses the charging priceclass of US$2.49 and the magic message ID through PHP page, e.g. “sendsmipx.php”, so that the user can be sent the charging premium SMS-MT, and “sendsmipx.php” creates the log of outgoing SMS.

Steps, Components, Functions 765 and 770 where the process starts over.

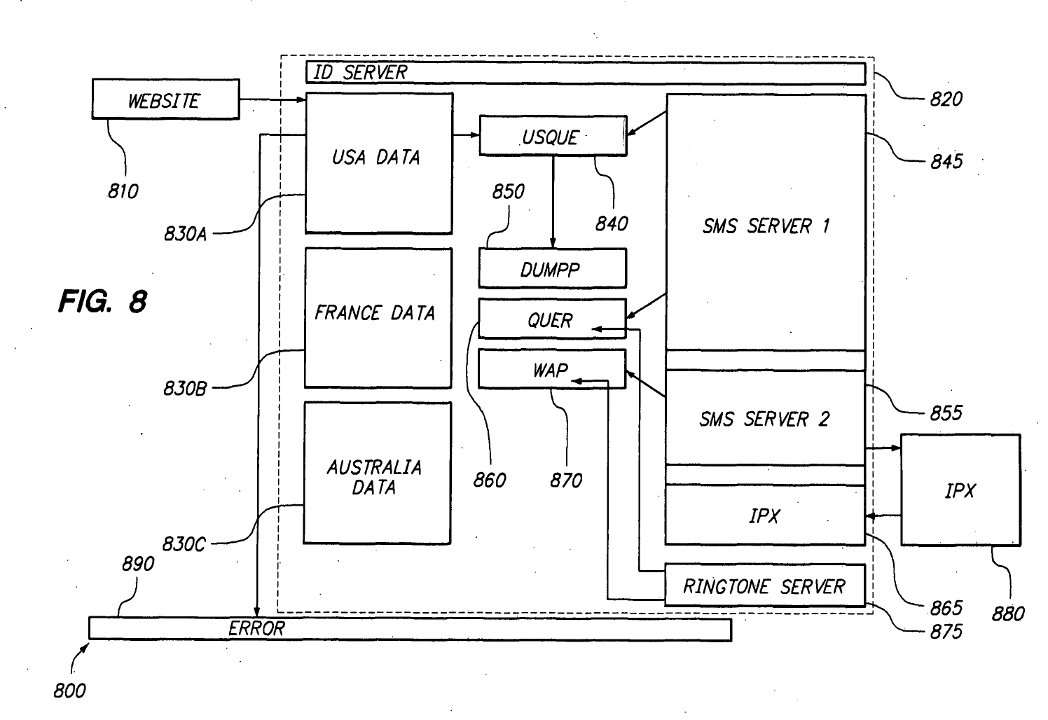

FIG. 8 shows a flow chart of databases used in a multimedia system and method of the present invention. Generally speaking, the databases 800 may comprise one or more of the following features: a website 810 connected to an ID Server 820 connected to an Error subroutine 890 and an IPX 880.

The website 810 sends strings to the ID Server 820, and specifically to an appropriate Request collection script for USA DATA 830A, FRANCE DATA 830B or AUSTRALIA DATA 830C, or any other database created for use with users in a particular country. The strings of the website 810 may contain one or more of the following: a short code, an origin add (MSISDN), a phone model, an operator, a product ID, a free voucher code, a custom cut information field, a priceclass, as required, a string example and a purchase from field, as required.

Each of the USA DATA 830A, FRANCE DATA 830B or AUSTRALIA DATA 830C holds the script in a wap folder for each country and passes data to a database. From the USA DATA 830A, FRANCE DATA 830B or AUSTRALIA DATA 830C, the process utilizes one or more of the USQUE table 840, which is connected to the DUMPP table 850, the QUER table 860 and the WAP table 870. The USQUE table 840 and the QUER table 860 interact with the SMS SERVER 1 845 and the SMS SERVER 2 855.

In the SMS SERVER 1 845, a VB Code sniffs the USQUE data for changes every 3 or 4 seconds, for example, copies from USQUE to DUMPP, then deletes data from USQUE, processes the data, checks that the data is from the appropriate address, e.g. “97786” in the USA version. If the data is not from the appropriate address, then the SMS SERVER 1 845 deletes the data as a protection against unwanted requests. Otherwise, the SMS SERVER 1 845 checks the validity of the string for information such as the stop and stop time of a track of a ringtone, performs one or more error checks on the string, and if any are true, sends an error via SMS to the user. The errors are described in the ERROR subroutine 890 but are not stored in this database. If there are no errors, the SMS SERVER 1 845 passes the string to the QUER table and goes to the next message.

The SMS SERVER 2 855 checks the WAP table every 3 or 4 seconds for any new links, and if there are, it processes the link in a manner appropriate for the particular carrier. For example, when Sprint is the carrier, the SMS SERVER 2 855 creates a GCD file and sends the link to IPX 880. Otherwise, for example, if the carrier is not Sprint, then the link passes in the WAP table to the user via IPX 880.

The IPX 880 receives an initial request and returns any message to the web page from which it was sent. Messages from IPX 865 come to the web pages, e.g. “sendsmipx.php” to “sendwappush.php” and the IPX message displays on the PHP page. This is the end of this particular portion of the process.

A RINGTONE SERVER 875 also interacts with the QUER table 860 and the WAP table 870. The RINGTONE SERVER 875 comprises one or more of the following functions: RINGTONE SERVER 875 data is stored in the QUER table 880, reads values from the QUER table 880, checks the string passed to it by SMS SERVER just like the SMS SERVER, error checks the string in the same manner as discussed above and continues to the next message. Otherwise, the RINGTONE SERVER 875 cuts the clip, encodes the dip and creates a link according to the country and operator, passes the link to the WAP table in the database and continues with the next message.

The ERROR subroutine 890 may include one or more of the following functions: flags errors, shows string errors, shows MSISDN, shows attempted purchase timestamps, identifies the exact error in the string if encountered, and sends the user corrections via a manual WAP-push or automated process. The ERROR subroutine 890 may, for example, include one or more of the following internal ID error response codes: 1. Code: OPERATOR, Description: OPERATOR CODE INCORRECT, 2. Code: MSISDN LENGTH, Description: INCORRECT LENGTH OF MSISDN.

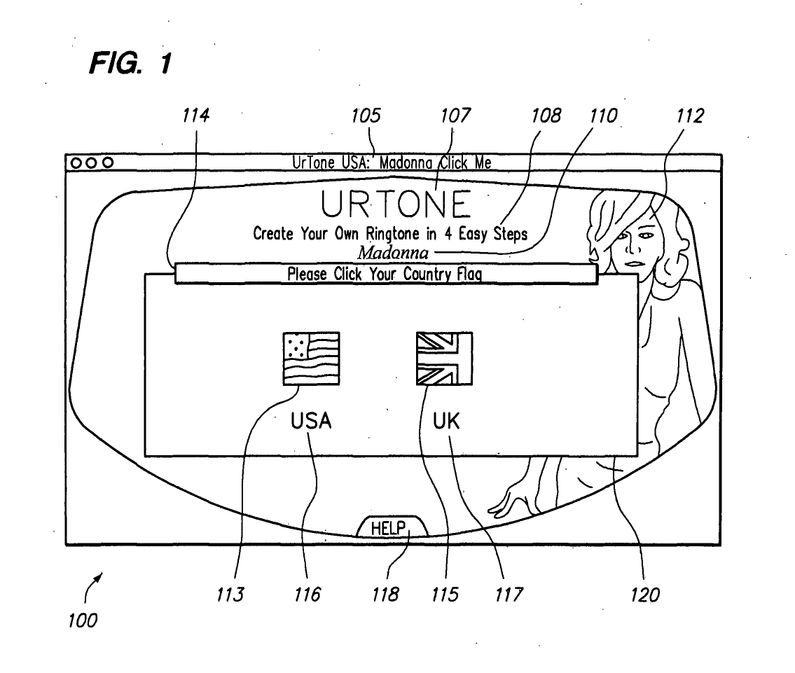

FIG. 1 shows a screenshot of one portion of a multi-step, multi-component, multi-function process for a multimedia system and method of the present invention, where a country or language is selected. In this step, component, function 100, a user may be presented with the one or more of the following information fields and options: a page title 105, e.g. “UrTone USA:Madonna Click Me”, a company logo 107, e.g. “URTONE”, a tagline 108, e.g. “Create Your Own Ringtone in 4 Easy Steps”, artist name 110, e.g. “MADONNA”, artist image or other graphic 112, e.g. a photo of Madonna, a step or action description 114, e.g. “please Click on Your Country Flag”, a link to a help screen 118, e.g. “HELP”, and an action box 120 containing one or more of the following: an image and link associated with a first country 113, e.g. the US flag, text designating the first country 115, e.g. “USA”, an image and link associated with a second country 116, e.g. the UK flag, and text designating the second country 117, e.g. “UK”.

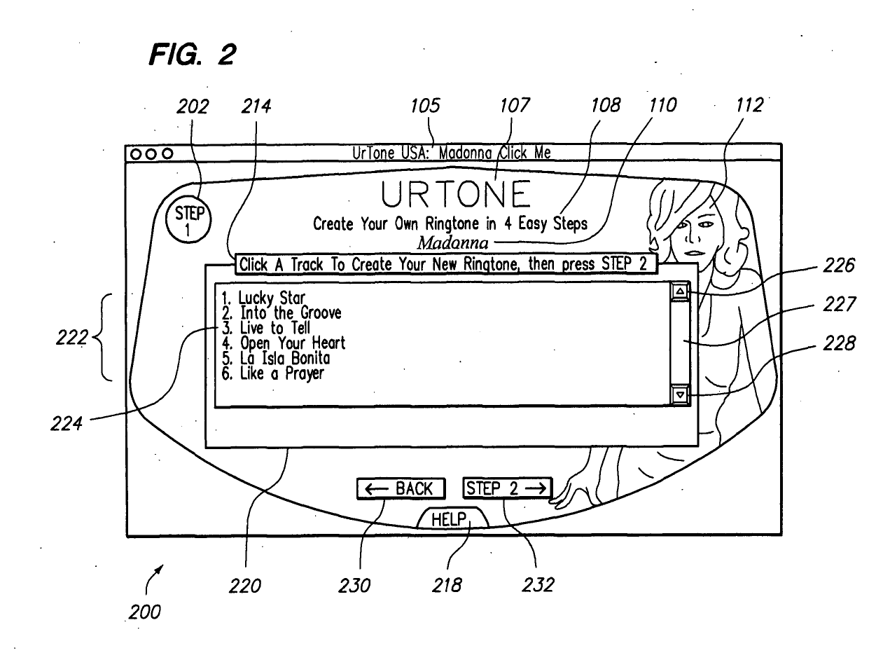

FIG. 2 shows a screenshot of one portion of a multi-step, multi-component, multi-function process for a multimedia system and method of the present invention, where a track is selected. In this step, component, function 200, a user may be presented with the one or more of the following information fields and options: a page title 105, a company logo 107, a tagline 108, artist name 110, artist image or other graphic 112, a step indicator 202, e.g. “STEP 1”, a step or action description 214, e.g. “Click A Track To Create Your New Ringtone, then press STEP 2”, a link to a help screen 218, a back button 230, e.g. “BACK”, a next step button 232, e.g. “STEP 2”, and an action box 220 containing one or more of the following: a list of tracks 222, e.g. “1. Lucky Star”, “2. Into the Groove”, “3. Live to Tell”, “4. Open Your Heart”, “5. La Isla Bonita” and “6. Like a Prayer”, a selected track 224, e.g. “3. Live to Tell”, and a slide bar 227 with an up arrow 226 and a down arrow 228.

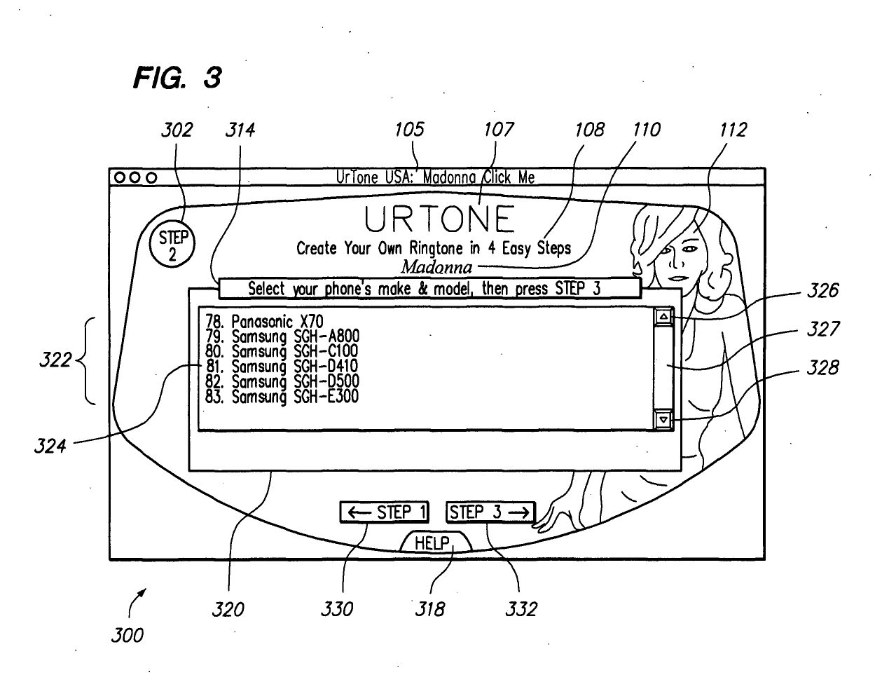

FIG. 3 shows a screenshot of one portion of a multi-step, multi-component, multi-function process for a multimedia system and method of the present invention, where a make and model of a mobile telephone is selected. In this step, component, function 300, a user may be presented with the one or more of the following information fields and options: a page title 105, a company logo 107, a tagline 108, artist name 110, artist image or other graphic 112, a step indicator 302, e.g. “STEP 2”, a step or action description 314, e.g. “Select your phone's make & model, then press STEP 3”, a link to a help screen 318, a back button 330, e.g. “STEP 1”, a next step button 332, e.g. “STEP 3”, and an action box 320 containing one or more of the following: a list of devices 322, e.g. “78. Samsung X70”, “79. Samsung SGH-A800, “80. Samsung SGH-C100”, “81. Samsung SGH-D410”, “82. Samsung SGH-D500”, and “83. Samsung SGH-E300”, a selected device 324, e.g. “81. Samsung SGH-D410”, and a slide bar 327 with an up arrow 326 and a down arrow 328.

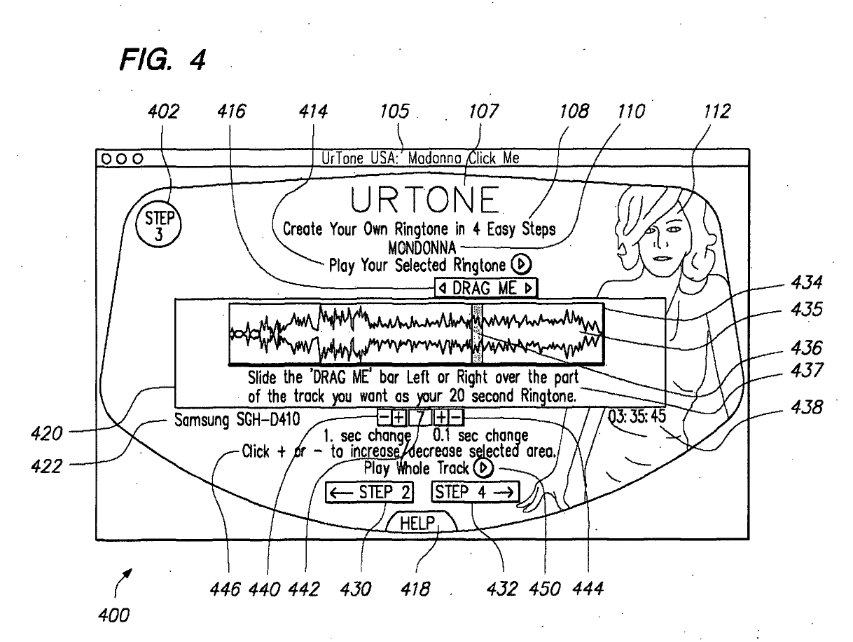

FIG. 4 shows a screenshot of one portion of a multi-step, multi-component, multi-function process for a multimedia system and method of the present invention, where a track is edited. In this step, component, function 400, a user may be presented with the one or more of the following information fields and options: a page title 105, a company logo 107, a tagline 108, artist name 110, artist image or other graphic 112, a step indicator 402, e.g. “STEP 3”, a step or action description 414, e.g. “Play Your Selected Ringtone”, a sliding selector bar 416, e.g. “DRAG ME”, a link to a help screen 418, a selected device field 422, e.g. “Samsung SGH-D410” corresponding with the selected device 324, a back button 430, e.g. “STEP 2”, a next step button 432, e.g. “STEP 4”, an indicator for showing the total length of the track 438, e.g. “03:36:45”, a pair of boxes for increasing or decreasing the length of the track in seconds 440, a box for indicating the length of the selected portion of the track 442, e.g. “7”, a pair of boxes for increasing or decreasing the length of the track in tenths of a second 444, an action descriptor 446, e.g. “Click + or − to increase/decrease selected area.”, a button for playing the entire track 450, e.g. “Play Whole Track”, and an action box 420 containing one-or more of the following: a box for displaying a waveform of a track 434, a waveform of a track 435, a selected portion of a track 436 and an instruction field 437, e.g. “Slide the ‘DRAG ME’ bar Left or Right over the part of the track you want as your 20 second Ringtone”.

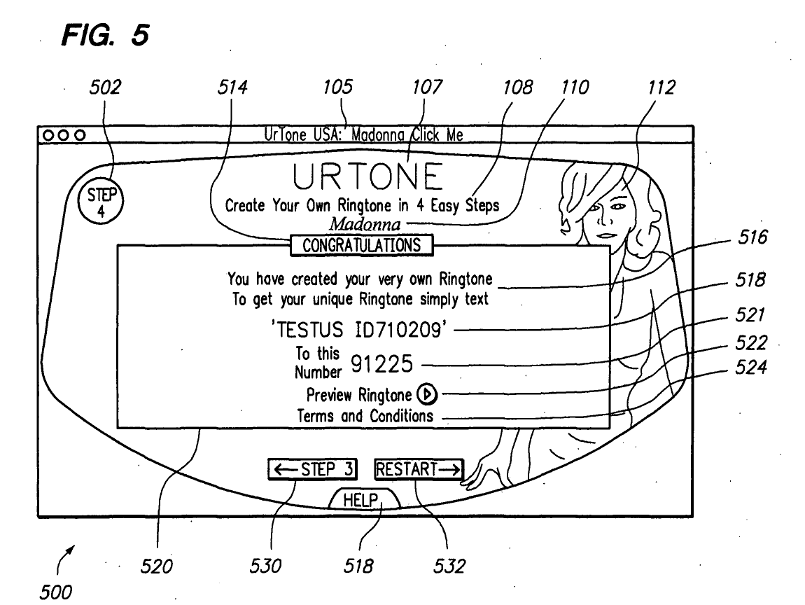

FIG. 5 shows a screenshot of one portion of a multi-step, multi-component, multi-function process for a multimedia system and method of the present invention, where information relating to the transfer of a ringtone is displayed. In this step, component, function 500, a user may be presented with the one or more of the following information fields and options: a page title 105, a company logo 107, a tagline 108, artist name 110, artist image or other graphic 112, a step indicator 502, e.g. “STEP 4”, a step or action description 514, e.g. “CONGRATULATIONS”, a link to a help screen 518, a back button 530, e.g. “STEP 3”, a next step or restart button 532, e.g. “RESTART”, and an action box 520 containing one or more of the following: an information field 516, e.g. “You have created your very own Ringtone” and “To get your unique Ringtone simply text”, a first identification number 518, e.g. “TESTUS ID710209’”, a second identification number 521, e.g. “To this Number” and “91225”, a preview ringtone button 522, e.g. “Preview Ringtone”, and a link to a terms and conditions page 524, e.g. “Terms and Conditions”.

Although FIGS. 1-5 show separate screens, it is noted that any combination of steps, components and functions may be performed on one or more screens. For example, steps, components, functions 100, 200, 300 and 400 may be performed on one screen where pertinent information updates as the user progresses through the selection process. For example, a single screen may display a STEP 1 for selecting a track that includes drop down menus for selecting an individual artist. When an artist is selected, a drop down menu updates for tracks that correspond with the selected artist; a STEP 2 for selecting a phone and carrier including drop down menus for a phone model and a carrier; a STEP 3 for creating a custom ringtone including some or all of the features described with respect to FIG. 4 above; and a STEP 4 for purchasing a custom ringtone including a field for entering a cell phone number. The screen may include a “BUY NOW” button and a price displayed next to the “BUT NOW” button.

Although the above descriptions discuss ringtones, it should be noted that the present invention includes a system and method for distributing other types of media such as video tones, applications (bespoke or off-the-shelf), games, screensavers, wallpaper and the like. The present invention is not limited to the descriptions provided above, but includes any suitable process descriptor, graphic or field necessary to select, edit and download all types of media files including those types mentioned herein and transfer such media files to mobile or cellular telephones, media storage devices, websites, electronic cards and the like.

The present invention includes a method comprising selecting a country of citizenship; picking a song from a predetermined list; selecting a radio phone make and model of a user; sliding a drag me bar left or right on a sound spectrum graph of the song, the drag me bar has a time window with a length of time that corresponds with the radio phone make and model; creating your own ringtone, video tone, application, game, screensaver, wallpaper or the like for the radio phone from the time window; and transferring the ringtone, video tone, application, game, screensaver, wallpaper or the like from a user interface to the radio phone. The length of time may be in a range of 5 to 50 seconds.

The present invention includes-a method comprising picking a song from a predetermined list; selecting a device make and model of a user; sliding a drag me bar left or right on a sound spectrum graph of the song, the drag me bar has a time window with a length of time that corresponds with the radio phone make and model; creating your own ringtone, video tone, application, game, screensaver, wallpaper or the like for the device from the time window; and transferring the ringtone, video tone, application, game, screensaver, wallpaper or the like from a user interface to the device. The device may be selected from one of the group consisting of a cell phone, PDA, notebook computer, PC computer and car radio. The length of time may be in a range of 5 to 50 seconds. The user interface may be a website or a kiosk.

The present invention includes a user customized ring tone comprising a predetermined list to pick a song; a device make and model of a user; a drag me bar slide left and right on a wave form graph of the song, the drag me bar has a time window with a length of time that corresponds to a ringtone, video tone, application, game, screensaver, wallpaper or the like length of the device make and model, the time window creates the length of time for ringtone, video tone, application, game, screensaver, wallpaper or the like; and a user interface to transfer the ringtone, video tone, application, game, screensaver, wallpaper or the like to the device.

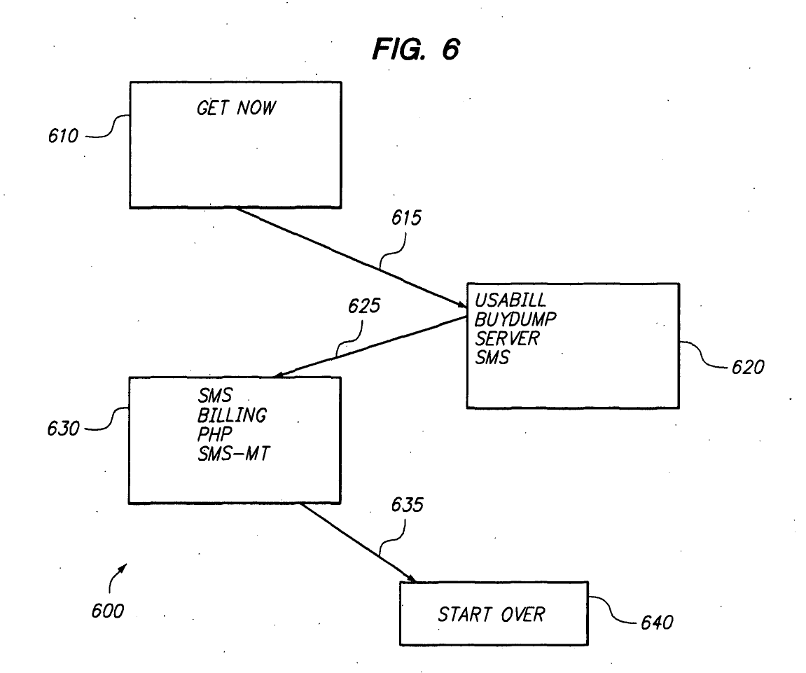

The present invention may include various databases for managing data associated with the present system and method. Each database may include multiple tables and each table may include fields for storing an identification number, name of a field, the type of data for each field, the size of each field and other information for managing data in the databases. These databases and tables are shown, for example, in FIGS. 6-8. In the following tables, K=In Primary key, I=Identity Column, G=Row Guid, N=Allow Nulls and C=Computed.

The DATABASE SERVER may comprise the following tables:

The “america” table is used to save the result set generated by the report pages for US clients, so that then they can be sorted and displayed in an order by downloads.

TABLE 1
“america”

| Id | Name | Data Type | Size | K | I | G | N | C | Num(P, S) | Ident(S, I) | Extended Properties |
|---|---|---|---|---|---|---|---|---|---|---|---|
| 1 | artist | varchar | 250 | — | — | — | Y | — | (0, 0) | (0, 0) | |
| 6 | atnt | numeric | 9 | — | — | — | Y | — | (18, 0) | (0, 0) | |
| 5 | cingular | numeric | 9 | — | — | — | Y | — | (18, 0) | (0, 0) | |
| 3 | isrc | varchar | 250 | — | — | — | Y | — | (0, 0) | (0, 0) | |
| 7 | sprint | numeric | 9 | — | — | — | Y | — | (18, 0) | (0, 0) | |
| 2 | titles | varchar | 250 | — | — | — | Y | — | (0, 0) | (0, 0) | |
| 4 | tmobile | numeric | 9 | — | — | — | Y | — | (18, 0) | (0, 0) | |
| 8 | total | numeric | 9 | — | — | — | Y | — | (18, 0) | (0, 0) | |

The “ausque” table is filled by the PHP page when an SMS arrives from IPX to the URTONE system for Australia.

TABLE 2
“ausque”

| Id | Name | Data Type | Size | K | I | G | N | C | Num(P, S) | Ident(S, I) | Extended Properties |
|---|---|---|---|---|---|---|---|---|---|---|---|
| 5 | messageid | nvarchar | 50 | — | — | — | Y | — | (0, 0) | (0, 0) | |
| 4 | messages | nvarchar | 50 | — | — | — | Y | — | (0, 0) | (0, 0) | |
| 6 | operator | nvarchar | 50 | — | — | — | Y | — | (0, 0) | (0, 0) | |
| 3 | originatoradress | nvarchar | 50 | — | — | — | Y | — | (0, 0) | (0, 0) | |
| 2 | shortcode | nvarchar | 50 | — | — | — | Y | — | (0, 0) | (0, 0) | |
| 1 | timestamp | nvarchar | 50 | — | — | — | Y | — | (0, 0) | (0, 0) | |

The “buydump” table is used to save and log what is sent back to a company using the present system and method when a user has pressed the buy link.

TABLE 3
“buydump”

| Id | Name | Data Type | Size | K | I | G | N | C | Num(P, S) | Ident(S, I) | Extended Properties |
|---|---|---|---|---|---|---|---|---|---|---|---|
| 1 | cellnumber | nvarchar | 50 | — | — | — | Y | — | (0, 0) | (0, 0) | |
| 3 | link | nvarchar | 50 | — | — | — | Y | — | (0, 0) | (0, 0) | |
| 2 | operator | nvarchar | 50 | — | — | — | Y | — | (0, 0) | (0, 0) | |

The “dumpp” table is filled with information about each SMS coming into the system regardless of the country.

TABLE 4
“dumpp”

| Id | Name | Data Type | Size | K | I | G | N | C | Num(P, S) | Ident(S, I) | Extended Properties |
|---|---|---|---|---|---|---|---|---|---|---|---|
| 5 | messageid | nvarchar | 50 | — | — | — | Y | — | (0, 0) | (0, 0) | |
| 4 | messages | nvarchar | 50 | — | — | — | Y | — | (0, 0) | (0, 0) | |
| 6 | operator | nvarchar | 50 | — | — | — | Y | — | (0, 0) | (0, 0) | |
| 3 | originatoradress | nvarchar | 50 | — | — | — | Y | — | (0, 0) | (0, 0) | |
| 2 | shortcode | nvarchar | 50 | — | — | — | Y | — | (0, 0) | (0, 0) | |
| 1 | timestamp | nvarchar | 50 | — | — | — | Y | — | (0, 0) | (0, 0) | |

The “firstgo” table is used by the flash file to save the Hit Statistics.

TABLE 5
“firstgo”

| Id | Name | Data Type | Size | K | I | G | N | C | Num(P, S) | Ident(S, I) | Extended Properties |
|---|---|---|---|---|---|---|---|---|---|---|---|
| 1 | pressed | nvarchar | 50 | — | — | — | Y | — | (0, 0) | (0, 0) | |

The “secondgo” table is used by the flash file to save the Hit Statistics.

TABLE 6
“secondgo”

| Id | Name | Data Type | Size | K | I | G | N | C | Num(P, S) | Ident(S, I) | Extended Properties |
|---|---|---|---|---|---|---|---|---|---|---|---|
| 1 | pressed | nvarchar | 50 | — | — | — | Y | — | (0, 0) | (0, 0) | |

The “thirdgo” table is used by the flash file to save the Hit Statistics.

TABLE 7
“thirdgo”

| Id | Name | Data Type | Size | K | I | G | N | C | Num(P, S) | Ident(S, I) | Extended Properties |
|---|---|---|---|---|---|---|---|---|---|---|---|
| 1 | pressed | nvarchar | 50 | — | — | — | Y | — | (0, 0) | (0, 0) | |

The “france” table is used to save the result set generated by the report pages for French clients, so that then they can be sorted and displayed in an order by downloads.

TABLE 8
“france”

| Id | Name | Data Type | Size | K | I | G | N | C | Num(P, S) | Ident(S, I) | Extended Properties |
|---|---|---|---|---|---|---|---|---|---|---|---|
| 1 | artist | varchar | 250 | — | — | — | Y | — | (0, 0) | (0, 0) | |
| 4 | Bouygues | numeric | 9 | — | — | — | Y | — | (18, 0) | (0, 0) | |
| 3 | isrc | varchar | 250 | — | — | — | Y | — | (0, 0) | (0, 0) | |
| 5 | Orange | numeric | 9 | — | — | — | Y | — | (18, 0) | (0, 0) | |
| 6 | Sfr | numeric | 9 | — | — | — | Y | — | (18, 0) | (0, 0) | |
| 2 | titles | varchar | 250 | — | — | — | Y | — | (0, 0) | (0, 0) | |
| 7 | Total | numeric | 9 | — | — | — | Y | — | (18, 0) | (0, 0) | |

FIG. 6 shows a flow chart of a precuts -procedure 600. The precuts procedure 600 may include one or more of the following components, functions or steps:

Step, Component, Function 610 where a Flash File is provided, a user enters a phone number and clicks a UGET NOW or similar button.

Step, Component, Function 615 where the Flash File sends the information from the WAP table and sends it to the user via IPX, through a PHP page, e.g. “sendwappushipx.php”, which also creates a log of outgoing SMS. The entry is removed from the WAP table and an example of a link the user gets is as follows, where “Buy” is a link to the download media file: “[company name] Your customized ringtone is ready! Click Buy to download. Remember to save it once the download is complete. A one-off charge of $2.49 applies. To opt-out reply with STOP.”

Step, Component, Function 620 where a user executes the link, downloads the ringtone, video tone, application, game, screensaver, wallpaper or the like, sends the following values to USABILL and BUYDUMP tables in SERVER database: 1. Cell number; 2. Operator; 3. the Link the user was shown. These values stay in the system until consumed by the SMS server for billing.

Step, Component, Function 625 where SMS server clears the USABILL table off the information received from the user's handset when the user executed the link and processes it for billing.

Step, Component, Function 630 where SMS server places a comprehensive billing in the URTONE database BILLING table and uses the charging priceclass of US$2.49 and the magic message ID through PHP page, e.g. “sendsmipx.php”, so that the user can be sent the charging premium SMS-MT, and “sendsmipx.php” creates the log of outgoing SMS.

Step, Component, Function 640 where the process starts over.

The “precutdump” table is used to store log information of the precut links.

TABLE 9
“precutdump”

| Id | Name | Data Type | Size | K | I | G | N | C | Num(P, S) | Ident(S, I) | Extended Properties |
|---|---|---|---|---|---|---|---|---|---|---|---|
| 1 | cellnumber | nvarchar | 50 | — | — | — | Y | — | (0, 0) | (0, 0) | |
| 4 | datetime | datetime | 8 | — | — | — | Y | — | (0, 0) | (0, 0) | |
| 3 | link | nvarchar | 50 | — | — | — | Y | — | (0, 0) | (0, 0) | |
| 2 | operator | nvarchar | 50 | — | — | — | Y | — | (0, 0) | (0, 0) | |

The “que” table is filled by the PHP page when an SMS arrives from IPX to the URTONE system for France

TABLE 10
“que”

| | | Data | | | | | | | | | Extended |
|---|---|---|---|---|---|---|---|---|---|---|---|
| Id | Name | Type | Size | K | I | G | N | C | Num(P, S) | Ident(S, I) | Properties |
| 5 | messageid | nvarchar | 50 | — | — | — | Y | — | (0, 0) | (0, 0) | |
| 4 | messages | nvarchar | 50 | — | — | — | Y | — | (0, 0) | (0, 0) | |
| 6 | operator | nvarchar | 50 | — | — | — | Y | — | (0, 0) | (0, 0) | |
| 3 | originatoradress | nvarchar | 50 | — | — | — | Y | — | (0, 0) | (0, 0) | |
| 2 | shortcode | nvarchar | 50 | — | — | — | Y | — | (0, 0) | (0, 0) | |
| 1 | timestamp | nvarchar | 50 | — | — | — | Y | — | (0, 0) | (0, 0) | |

After the data in the “que” table goes through SMS servers, the information is placed in the “quer” table so that the ringtone server can delete it from there, process the order and send it to WAP.

TABLE 11
“quer”

| Id | Name | Data Type | Size | K | I | G | N | C | Num(P, S) | Ident(S, I) | Extended Properties |
|---|---|---|---|---|---|---|---|---|---|---|---|
| 5 | messageid | nvarchar | 50 | — | — | — | Y | — | (0, 0) | (0, 0) | |
| 4 | messages | nvarchar | 50 | — | — | — | Y | — | (0, 0) | (0, 0) | |
| 6 | operator | nvarchar | 50 | — | — | — | Y | — | (0, 0) | (0, 0) | |
| 3 | originatoradress | nvarchar | 50 | — | — | — | Y | — | (0, 0) | (0, 0) | |
| 2 | shortcode | nvarchar | 50 | — | — | — | Y | — | (0, 0) | (0, 0) | |
| 1 | timestamp | nvarchar | 50 | — | — | — | Y | — | (0, 0) | (0, 0) | |

The “request” table is used to store the OUI agree message to be saved until the SMS server compares it with the order and sends the user the WAP-push of the content that needs to be downloaded.

TABLE 12
“request”

| Id | Name | Data Type | Size | K | I | G | N | C | Num(P, S) | Ident(S, I) | Extended Properties |
|---|---|---|---|---|---|---|---|---|---|---|---|
| 3 | cellnumber | nvarchar | 50 | — | — | — | Y | — | (0, 0) | (0, 0) | |
| 4 | country | nvarchar | 50 | — | — | — | Y | — | (0, 0) | (0, 0) | |
| 2 | message | nvarchar | 50 | — | — | — | Y | — | (0, 0) | (0, 0) | |
| 6 | messageid | nvarchar | 50 | — | — | — | Y | — | (0, 0) | (0, 0) | |
| 5 | operator | nvarchar | 50 | — | — | — | Y | — | (0, 0) | (0, 0) | |
| 1 | shortcode | nvarchar | 50 | — | — | — | Y | — | (0, 0) | (0, 0) | |

The “session” table is used to contain the order code for content against the session created by the user by using the flash file. When the order is claimed, the session becomes free of order code. This is used for French orders.

TABLE 13
“session”

| Id | Name | Data Type | Size | K | I | G | N | C | Num(P, S) | Ident(S, I) | Extended Properties |
|---|---|---|---|---|---|---|---|---|---|---|---|
| 1 | ordercode | nvarchar | 20 | — | — | — | Y | — | (0, 0) | (0, 0) | |
| 2 | ordernumber | nvarchar | 3 | — | — | — | Y | — | (0, 0) | (0, 0) | |
| 3 | ordertime | datetime | 8 | — | — | — | Y | — | (0, 0) | (0, 0) | |

The “sessionaus” table is used to contain session information for Australian order codes.

TABLE 14
“sessionaus”

| Id | Name | Data Type | Size | K | I | G | N | C | Num(P, S) | Ident(S, I) | Extended Properties |
|---|---|---|---|---|---|---|---|---|---|---|---|
| 1 | ordercode | nvarchar | 20 | — | — | — | Y | — | (0, 0) | (0, 0) | |
| 2 | ordernumber | nvarchar | 3 | — | — | — | Y | — | (0, 0) | (0, 0) | |
| 3 | ordertime | datetime | 8 | — | — | — | Y | — | (0, 0) | (0, 0) | |

The “smsdump” table contains the IPX response to the outgoing SMS for USA, which is basically a log created on the basis of the time on which SMS is sent.

TABLE 15
“smsdump”

| Id | Name | Data Type | Size | K | I | G | N | C | Num(P, S) | Ident(S, I) | Extended Properties |
|---|---|---|---|---|---|---|---|---|---|---|---|
| 2 | cellnumber | nvarchar | 15 | — | — | — | Y | — | (0, 0) | (0, 0) | |
| 3 | message | nvarchar | 200 | — | — | — | Y | — | (0, 0) | (0, 0) | |
| 4 | messageid | nvarchar | 20 | — | — | — | Y | — | (0, 0) | (0, 0) | |
| 5 | responsecode | nvarchar | 15 | — | — | — | Y | — | (0, 0) | (0, 0) | |
| 6 | responsetext | nvarchar | 200 | — | — | — | Y | — | (0, 0) | (0, 0) | |
| 7 | times | datetime | 8 | — | — | — | Y | — | (0, 0) | (0, 0) | |
| 1 | type | nvarchar | 20 | — | — | — | Y | — | (0, 0) | (0, 0) | |

The “usabill” table is used to hold the Buy button click information so that the content customer can be charged appropriately.

TABLE 16
“usabill”

| Id | Name | Data Type | Size | K | I | G | N | C | Num(P, S) | Ident(S, I) | Extended Properties |
|---|---|---|---|---|---|---|---|---|---|---|---|
| 1 | cellnumber | nvarchar | 50 | — | — | — | Y | — | (0, 0) | (0, 0) | |
| 3 | link | nvarchar | 50 | — | — | — | Y | — | (0, 0) | (0, 0) | |
| 2 | operator | nvarchar | 50 | — | — | — | Y | — | (0, 0) | (0, 0) | |

The “usque” table is filled by the PHP page when an SMS arrives from IPX to the URTONE system for USA.

TABLE 17
“usque”

| Id | Name | Data Type | Size | K | I | G | N | C | Num(P, S) | Ident(S, I) | Extended Properties |
|---|---|---|---|---|---|---|---|---|---|---|---|
| 5 | messageid | nvarchar | 50 | — | — | — | Y | — | (0, 0) | (0, 0) | |
| 4 | messages | nvarchar | 50 | — | — | — | Y | — | (0, 0) | (0, 0) | |
| 6 | operator | nvarchar | 50 | — | — | — | Y | — | (0, 0) | (0, 0) | |
| 3 | originatoradress | nvarchar | 50 | — | — | — | Y | — | (0, 0) | (0, 0) | |
| 2 | shortcode | nvarchar | 50 | — | — | — | Y | — | (0, 0) | (0, 0) | |
| 1 | timestamp | nvarchar | 50 | — | — | — | Y | — | (0, 0) | (0, 0) | |

The “wap” table holds the information of the links constructed by the Ringtone server and is cleared when the SMS server anticipates this information and sends it to the user as a WAP-push.

TABLE 18
“wap”

| Id | Name | Data Type | Size | K | I | G | N | C | Num(P, S) | Ident(S, I) | Extended Properties |
|---|---|---|---|---|---|---|---|---|---|---|---|
| 3 | cellnumber | nvarchar | 50 | — | — | — | Y | — | (0, 0) | (0, 0) | |
| 2 | message | nvarchar | 255 | — | — | — | Y | — | (0, 0) | (0, 0) | |
| 6 | messageid | nvarchar | 50 | — | — | — | Y | — | (0, 0) | (0, 0) | |
| 5 | operator | nvarchar | 50 | — | — | — | Y | — | (0, 0) | (0, 0) | |
| 1 | shortcode | nvarchar | 50 | — | — | — | Y | — | (0, 0) | (0, 0) | |
| 4 | songid | nvarchar | 50 | — | — | — | Y | — | (0, 0) | (0, 0) | |

The DATABASE URTONE may comprise the following tables:

The “billing” table saves the billing information for content purchased in any country, client, artist or project.

TABLE 19
“billing”

| Id | Name | Data Type | Size | K | I | G | N | C | Num(P, S) | Ident(S, I) | Extended Properties |
|---|---|---|---|---|---|---|---|---|---|---|---|
| 17 | album | nvarchar | 255 | — | — | — | Y | — | (0, 0) | (0, 0) | |
| 14 | artist | nvarchar | 255 | — | — | — | Y | — | (0, 0) | (0, 0) | |
| 4 | client | nvarchar | 255 | — | — | — | Y | — | (0, 0) | (0, 0) | |
| 8 | clienttariff | nvarchar | 255 | — | — | — | Y | — | (0, 0) | (0, 0) | |
| 10 | country | nvarchar | 255 | — | — | — | Y | — | (0, 0) | (0, 0) | |
| 3 | date_times | smalldatetime | 4 | — | — | — | Y | — | (0, 0) | (0, 0) | |
| 16 | Download | int | 4 | — | — | — | Y | — | (0, 0) | (0, 0) | |
| 9 | internaltariff | nvarchar | 255 | — | — | — | Y | — | (0, 0) | (0, 0) | |
| 13 | noms | int | 4 | — | — | — | Y | — | (0, 0) | (0, 0) | |
| 1 | operator | nvarchar | 255 | — | — | — | Y | — | (0, 0) | (0, 0) | |
| 7 | payout | nvarchar | 255 | — | — | — | Y | — | (0, 0) | (0, 0) | |
| 6 | priceclass | nvarchar | 255 | — | — | — | Y | — | (0, 0) | (0, 0) | |
| 5 | shortcode | nvarchar | 255 | — | — | — | Y | — | (0, 0) | (0, 0) | |
| 2 | titles | nvarchar | 255 | — | — | — | Y | — | (0, 0) | (0, 0) | |
| 11 | track | nvarchar | 255 | — | — | — | Y | — | (0, 0) | (0, 0) | |
| 12 | waplink | nvarchar | 150 | — | — | — | Y | — | (0, 0) | (0, 0) | |

The “client” table contains the information about the client like a music company's name, its contacts, phone numbers address and country details, etc..

TABLE 20
“client”

| Id | Name | Data Type | Size | K | I | G | N | C | Num(P, S) | Ident(S, I) | Extended Properties |
|---|---|---|---|---|---|---|---|---|---|---|---|
| 2 | address | ntext | 16 | — | — | — | Y | — | (0, 0) | (0, 0) | |
| 7 | city | nvarchar | 255 | — | — | — | Y | — | (0, 0) | (0, 0) | |
| 1 | client | nvarchar | 255 | — | — | — | Y | — | (0, 0) | (0, 0) | |
| 3 | contact | nvarchar | 255 | — | — | — | Y | — | (0, 0) | (0, 0) | |
| 11 | country | nvarchar | 255 | — | — | — | Y | — | (0, 0) | (0, 0) | |
| 6 | email1 | nvarchar | 255 | — | — | — | Y | — | (0, 0) | (0, 0) | |
| 16 | email2 | nvarchar | 255 | — | — | — | Y | — | (0, 0) | (0, 0) | |
| 20 | email3 | nvarchar | 255 | — | — | — | Y | — | (0, 0) | (0, 0) | |
| 24 | email4 | nvarchar | 255 | — | — | — | Y | — | (0, 0) | (0, 0) | |
| 28 | email5 | nvarchar | 255 | — | — | — | Y | — | (0, 0) | (0, 0) | |
| 9 | fax | nvarchar | 255 | — | — | — | Y | — | (0, 0) | (0, 0) | |
| 4 | first1 | nvarchar | 255 | — | — | — | Y | — | (0, 0) | (0, 0) | |
| 14 | first2 | nvarchar | 255 | — | — | — | Y | — | (0, 0) | (0, 0) | |
| 18 | first3 | nvarchar | 255 | — | — | — | Y | — | (0, 0) | (0, 0) | |
| 22 | first4 | nvarchar | 255 | — | — | — | Y | — | (0, 0) | (0, 0) | |
| 26 | first5 | nvarchar | 255 | — | — | — | Y | — | (0, 0) | (0, 0) | |
| 5 | last1 | nvarchar | 255 | — | — | — | Y | — | (0, 0) | (0, 0) | |
| 15 | last2 | nvarchar | 255 | — | — | — | Y | — | (0, 0) | (0, 0) | |
| 19 | last3 | nvarchar | 255 | — | — | — | Y | — | (0, 0) | (0, 0) | |
| 23 | last4 | nvarchar | 255 | — | — | — | Y | — | (0, 0) | (0, 0) | |
| 27 | last5 | nvarchar | 255 | — | — | — | Y | — | (0, 0) | (0, 0) | |
| 13 | line1 | nvarchar | 255 | — | — | — | Y | — | (0, 0) | (0, 0) | |
| 17 | Iine2 | nvarchar | 255 | — | — | — | Y | — | (0, 0) | (0, 0) | |
| 21 | line3 | nvarchar | 255 | — | — | — | Y | — | (0, 0) | (0, 0) | |
| 25 | line4 | nvarchar | 255 | — | — | — | Y | — | (0, 0) | (0, 0) | |
| 29 | line5 | nvarchar | 255 | — | — | — | Y | — | (0, 0) | (0, 0) | |
| 12 | sign | nvarchar | 255 | — | — | — | Y | — | (0, 0) | (0, 0) | |
| 8 | state | nvarchar | 255 | — | — | — | Y | — | (0, 0) | (0, 0) | |
| 10 | zip | nvarchar | 255 | — | — | — | Y | — | (0, 0) | (0, 0) | |

The “codes” table saves the information of shortcode and its priceclass, for each client with its tariff in each country.

TABLE 21
“codes”

| Id | Name | Data Type | Size | K | I | G | N | C | Num(P, S) | Ident(S, I) | Extended Properties |
|---|---|---|---|---|---|---|---|---|---|---|---|
| 2 | client | nvarchar | 255 | — | — | — | Y | — | (0, 0) | (0, 0) | |
| 5 | clienttariff | nvarchar | 10 | — | — | — | Y | — | (0, 0) | (0, 0) | |
| 1 | country | nvarchar | 255 | — | — | — | Y | — | (0, 0) | (0, 0) | |
| 4 | priceclass | nvarchar | 10 | — | — | — | Y | — | (0, 0) | (0, 0) | |
| 3 | shortcode | nvarchar | 20 | — | — | — | Y | — | (0, 0) | (0, 0) | |

The “operators” table contains the information for the operators, their SMS message texts and their payouts against each priceclass.

TABLE 22
“operators”

| Id | Name | Data Type | Size | K | I | G | N | C | Num(P, S) | Ident(S, I) | Extended Properties |
|---|---|---|---|---|---|---|---|---|---|---|---|
| 2 | country | nvarchar | 255 | — | — | — | Y | — | (0, 0) | (0, 0) | |
| 9 | helpmsg | ntext | 16 | — | — | — | Y | — | (0, 0) | (0, 0) | |
| 6 | mt1 | nvarchar | 160 | — | — | — | Y | — | (0, 0) | (0, 0) | |
| 7 | mt2 | nvarchar | 150 | — | — | — | Y | — | (0, 0) | (0, 0) | |
| 8 | mt3 | nvarchar | 160 | — | — | — | Y | — | (0, 0) | (0, 0) | |
| 10 | mtresponse | ntext | 16 | — | — | — | Y | — | (0, 0) | (0, 0) | |
| 11 | mtstop | ntext | 16 | — | — | — | Y | — | (0, 0) | (0, 0) | |
| 3 | operator | nvarchar | 255 | — | — | — | Y | — | (0, 0) | (0, 0) | |
| 1 | priceclass | nvarchar | 255 | — | — | — | Y | — | (0, 0) | (0, 0) | |
| 5 | shortcode | nvarchar | 255 | — | — | — | Y | — | (0, 0) | (0, 0) | |
| 4 | tariff | nvarchar | 255 | — | — | — | Y | — | (0, 0) | (0, 0) | |

The “ops” table contains the unique operator names for each country.

TABLE 23
“ops”

| Id | Name | Data Type | Size | K | I | G | N | C | Num(P, S) | Ident(S, I) | Extended Properties |
|---|---|---|---|---|---|---|---|---|---|---|---|
| 2 | country | nvarchar | 50 | — | — | — | Y | — | (0, 0) | (0, 0) | |
| 1 | operator | nvarchar | 50 | — | — | — | Y | — | (0, 0) | (0, 0) | |

The “shortcode” table contains the unique shortcodes assigned in each country.

TABLE 24
“shortcode”

| Id | Name | Data Type | Size | K | I | G | N | C | Num(P, S) | Ident(S, I) | Extended Properties |
|---|---|---|---|---|---|---|---|---|---|---|---|
| 3 | country | nvarchar | 255 | — | — | — | Y | — | (0, 0) | (0, 0) | |
| 2 | priceclass | nvarchar | 10 | — | — | — | Y | — | (0, 0) | (0, 0) | |
| 1 | shortcode | nvarchar | 20 | — | — | — | Y | — | (0, 0) | (0, 0) | |

The “tracks” table contains information about the tracks of URTONE which belong to a particular client in a particular country and the information such as its id, client and project, etc. The billing is generated by getting the songid from the link sent to the user and searching for that appropriate information in the URTONE database.

TABLE 25
“tracks”

| Id | Name | Data Type | Size | K | I | G | N | C | Num(P, S) | Ident(S, I) | Extended Properties |
|---|---|---|---|---|---|---|---|---|---|---|---|
| 5 | Album | nvarchar | 255 | — | — | — | Y | — | (0, 0) | (0, 0) | |
| 12 | albumartist | nvarchar | 50 | — | — | — | Y | — | (0, 0) | (0, 0) | |
| 4 | Artist | nvarchar | 255 | — | — | — | Y | — | (0, 0) | (0, 0) | |
| 7 | check | nvarchar | 1 | — | — | — | Y | — | (0, 0) | (0, 0) | |
| 10 | isrc | nvarchar | 50 | — | — | — | Y | — | (0, 0) | (0, 0) | |
| 6 | newname | nvarchar | 255 | — | — | — | Y | — | (0, 0) | (0, 0) | |
| 8 | titles | nvarchar | 255 | — | — | — | Y | — | (0, 0) | (0, 0) | |
| 9 | track | nvarchar | 50 | — | — | — | Y | — | (0, 0) | (0, 0) | |
| 1 | trackname | nvarchar | 255 | — | — | — | Y | — | (0, 0) | (0, 0) | |
| 2 | trackpath | ntext | 16 | — | — | — | Y | — | (0, 0) | (0, 0) | |
| 11 | upc | nvarchar | 50 | — | — | — | Y | — | (0, 0) | (0, 0) | |
| 3 | vendor | nvarchar | 255 | — | — | — | Y | — | (0, 0) | (0, 0) | |

Examples of message flow for the present system and method are provided below for the USA, France and Australia.

Message Flow Example 1.

USA: (MT billing—1 per ringtone, video tone, application, game, screensaver, wallpaper or the like)

1. Get now from web site

2. Present system gets string from web site

3. Present system sends WAP-push to handset via IPX

4. IPX sends response

5. Handset gets WAP-push

6. Customer presses go

7. Present system logs that user has pressed go (web communication)

8. Customer sees web link

9. Customer clicks link and downloads content

10. System tracks link access and download

11. Systems knows download complete

12. System sends premium billing MT via IPX

13. IPX response

14. System expires the link so it cannot be accessed again

15. System deletes file if custom cut

Message Flow Example 2.

FRANCE: (MO billing—2×premium MO's per ringtone, video tone, application, game, screensaver, wallpaper or the like)

1. Customer sends initial MO (premium MO)

2. Present system sends confirmation of purchase SMS asking for reply of YES via IPX

3. IPX sends response

4. Customer sends 2nd MO (premium MO) with YES

5. Present system sends WAP-push to handset via IPX

6. IPX sends response

7. Handset gets WAP-push

8. Customer presses go

9. Present system logs that user has pressed go (web communication)

10. Customer sees web link

11. Customer clicks link and downloads content

12. System tracks link access and download

13. Systems knows download complete

14. System expires the link so it cannot be accessed again

15. System deletes file if custom cut

16. Delivery report from IPX (optional)

Message Flow Example 3.

AUSTRALIA: (MO & MT billing—1×premium MO & 1 premium MT×per ringtone, video tone, application, game, screensaver, wallpaper or the like)

1. Customer sends initial MO (premium MO)

2. Present systems send WAP-push to handset via IPX (premium MO)

3. IPX sends response

4. Handset gets WAP-push

5. Customer presses go

6. Present system logs that user has pressed go (web communication)

7. Customer sees web link

8. Customer clicks link and downloads content

9. System tracks link access and download

10. Systems knows download complete

11. System expires the link so it cannot be accessed again

12. System deletes file if custom cut

13. Delivery report from IPX (optional)

While the present invention has been related in terms of the foregoing embodiments, those skilled in the art will recognize that the invention is not limited to the embodiments depicted. The present invention can be practiced with modification and alteration within the spirit and scope of the appended claims. Thus, the description is to be regarded as illustrative instead of restrictive on the present invention.

1. A system for administering, designing and distributing content to a device, the system comprising:
a means for transferring content from a content owner to a storage system;
a means for interacting with a user;
a means for selection of desired content for the device;
a means for editing the desired content;
a means for requesting the desired content;
a means for processing the request;
a means for creating the desired content in a format that is accessible to the user's device; and
a means for notifying the user that the created, desired content is ready for use.

2. The system of claim 1, wherein the system comprises a Mobile Gateway Server.

3. The system of claim 1, wherein the system comprises IPX.

4. The system of claim 1, wherein the content is a selected one of a ringtone, video tone, bespoke application, off-the-shelf application, game, screensaver, and wallpaper.

5. The system of claim 1, wherein the device is a selected one of a mobile telephone, cellular telephone, media storage device, website, and electronic card.

6. The system of claim 1, the system comprising a means for selection of a type of device.

7. The system of claim 1, the system comprising a means for tracking sales of the content.

8. A computer implemented method for administering, designing and distributing content to a device, the method comprising:
transferring content from a content owner to a storage system;
interacting with a user;
selecting desired content for the device;
editing the desired content;
requesting the desired content;
processing the request;
creating the desired content in a format that is accessible to the user's device; and
notifying the user that the created, desired content is ready for use.

9. The method of claim 8, wherein the method comprises a Mobile Gateway Server.

10. The method of claim 8, wherein the method comprises IPX.

11. The method of claim 8, wherein the content is a selected one of a ringtone, video tone, bespoke application, off-the-shelf application, game, screensaver, and wallpaper.

12. The method of claim 8, wherein the device is a selected one of a mobile telephone, cellular telephone, media storage device, website, and electronic card.

13. The method of claim 8, the method comprising selecting a type of device.

14. The method of claim 8, the method comprising tracking sales of the content.

15. A user interface for use with a system for administering, designing and distributing content to a device, the user interface comprising:
a means for accessing content from a content owner;
a means for selecting desired content for the device;
a means for editing the desired content;
a means for requesting the desired content;
a means for processing the request;
a means for creating the desired content in a format that is accessible to the user's device;
a means for notifying the user that the created, desired content is ready for use;
a means for tracking sales of the content.

16. The user interface of claim 15, wherein the user interface comprises a Mobile Gateway Server.

17. The user interface of claim 15, wherein the user interface comprises IPX.

18. The user interface of claim 15, wherein the content is a selected one a ringtone, video tone, bespoke application, off-the-shelf application, game, screensaver, and wallpaper.

19. The user interface of claim 15, wherein the device is a selected one of a mobile telephone, cellular telephone, media storage device, website, and electronic card.

20. The user interface of claim 15, the user interface comprising a means for selecting a type of device.
